(19) United States
(12) Patent Application Publication
(10) Pub. No.: US 2026/0356727 A1
(43) Pub. Date: Nov. 12, 2026

(54) METHODS OF MAKING HOLLOW CORE OPTICAL FIBERS

(71) Applicant: CORNING INCORPORATED, CORNING, NY (US)

(72) Inventors: Chams Baker, Corning, NY (US); Antoine Gaston Denis Bisson, Painted Post, NY (US); Sushmit Sunil Kumar Goyal, Painted Post, NY (US); Ming-Jun Li, Horseheads, NY (US)

(21) Appl. No.: 19/663,825

(22) Filed: Apr. 30, 2026

Related U.S. Application Data
(60) Provisional application No. 63/804,008, filed on May 12, 2025.

(51) Int. Cl. C03B 37/012

(52) U.S. Cl. CPC C03B 37/01222; C03B 37/01254; C03B 2203/16

(57) ABSTRACT

A hollow core optical fiber preform that includes a core cane tube positioned radially within a hollow interior of an outer cladding tube such that an outer surface of the core cane tube is separated by an inner surface of the outer cladding tube by a gap, and one or more glass tubes positioned radially within a hollow interior of the core cane tube, the one or more glass tubes each contacting the core cane tube, and the one or more glass tubes each comprising an inner capillary.

### CROSS-REFERENCE TO RELATED APPLICATION

This Application claims the benefit of priority to U.S. Provisional Patent Application Serial Number 63/804008 filed on May 12, 2025, the content of which is relied upon and incorporated herein by reference in its entirety.

### FIELD OF THE DISCLOSURE

The present disclosure is generally directed to hollow core optical fiber preforms and to methods of making hollow core optical fibers with uniform dimensions from such hollow core optical fiber preforms.

### BACKGROUND OF THE DISCLOSURE

Anti-resonant hollow core optical fibers are traditionally comprised of a hollow, outer cladding inside of which a plurality of structural tubes are arranged. The structural tubes have a smaller diameter and thickness than the outer cladding. Each structural tube is bonded to an inner surface of the outer cladding such that the structural tubes are arranged about the inner circumference of the outer cladding. Furthermore, each structural tube runs parallel to a length of the outer cladding. A central portion of the outer cladding, around which the structural tubes are arranged, remains empty as an air-filled void. The resulting anti-resonant fiber guides light through the empty, central portion of the core. Such anti-resonant fibers are able to provide reduced optical loss of signal.

The structural tubes must have specific dimensions in order to transmit the optical signal within the air-filled void formed by the outer cladding. If the structural tubes are not made with such specific dimensions, the structural tubes will not act as anti-resonant members at a predetermined wavelength. However, producing structural tubes with precise dimensions in hollow core optical fibers is extremely difficult.

### SUMMARY OF THE DISCLOSURE

An exemplary approach to solve the object is described by the independent claims. Various embodiments are defined with the dependent claims.

The present disclosure is directed to a hollow core optical fiber and methods of making thereof. According to aspects of the present disclosure, hollow core optical fibers are manufactured to have precise and uniform dimensions. The hollow core fibers disclosed herein are produced from a hollow core optical fiber preform that comprises a core cane tube to restrict and limit the expansion of glass tubes. Therefore, the glass tubes in the preform do not over-expand and are able to expand uniformly together to produce the precisely produced structural tubes in the drawn optical fiber.

According to aspects of the present disclosure, a hollow core optical fiber preform is disclosed that comprises a core cane tube positioned radially within a hollow interior of an outer cladding tube such that an outer surface of the core cane tube is separated by an inner surface of the outer cladding tube by a gap, and one or more glass tubes are positioned radially within a hollow interior of the core cane tube, the one or more glass tubes each contacting the core cane tube, and the one or more glass tubes each comprising an inner capillary.

According to aspects of the present disclosure, a method of manufacturing a hollow core optical fiber from a hollow core optical fiber preform is disclosed, the method comprising positioning one or more glass tubes radially within a core cane tube and positioning the core cane tube radially within an outer cladding tube such that the core cane tube is separated from the outer cladding tube by a gap, controlling gas pressure within the one or more glass tubes so that the glass tubes radially expand in size, controlling gas pressure within a hollow core of the hollow core optical fiber so that the core cane tube radially expands in size such that a length of the gap decreases.

Although many different embodiments are listed, the embodiments may exist individually or in any combination as possible. Hereinafter exemplary embodiments are shown and described.

### BRIEF DESCRIPTION OF THE DRAWINGS

FIG. 1 illustrates a schematic of an exemplary hollow core optical fiber in perspective view, according to embodiments of the present disclosure;

FIG. 2 illustrates a cross-sectional view of the hollow core fiber of FIG. 1 along line A of FIG. 1, according to embodiments of the present disclosure;

FIG. 3 illustrates a cross-sectional view of another embodiment of a hollow core optical fiber, according to embodiments of the present disclosure;

FIG. 4 illustrates an enlarged cross-sectional view of a portion of the exemplary hollow core optical fiber of FIG. 1, according to embodiments of the present disclosure;

FIG. 5 illustrates a process for producing a hollow core optical fiber, according to embodiments of the present disclosure;

FIG. 6 illustrates a cross-sectional view of an exemplary hollow core optical fiber preform, according to embodiments of the present disclosure;

FIG. 7 illustrates a schematic of a fiber drawing system, according to embodiments of the present disclosure;

FIG. 8 illustrates an image of a comparative hollow core optical fiber;

FIGS. 9A-9C illustrate cross-sectional views of a hollow core optical fiber preform during a draw process, according to embodiments of the present disclosure;

FIG. 10 illustrates a cross-sectional view of another embodiment of a hollow core optical fiber preform, according to embodiments of the present disclosure;

FIG. 11 illustrates a longitudinal cross-sectional view of the hollow core optical fiber preform of FIG. 10;

FIG. 12 illustrates a cross-sectional view of another embodiment of a hollow core optical fiber preform, according to embodiments of the present disclosure;

FIG. 13 illustrates an image of a cross-sectional view of an exemplary hollow core optical fiber, according to embodiments of the present disclosure; and

FIG. 14 is a plot of the ratio of the wall thickness of a core cane tube to the wall thickness of an outer cladding tube in a hollow core optical fiber preform to the minimum distance D between adjacent structural tubes in a drawn hollow core optical fiber, according to embodiments of the present disclosure.

### DETAILED DESCRIPTION

Additional features and advantages of the disclosure will be set forth in the detailed description which follows and will be apparent to those skilled in the art from the description or recognized by practicing the disclosure as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

It will be understood by one having ordinary skill in the art that construction of the described disclosure, and other components, is not limited to any specific material. Other exemplary embodiments of the disclosure disclosed herein may be formed from a wide variety of materials, unless described otherwise herein.

It is also important to note that the construction and arrangement of the elements of the disclosure, as shown in the exemplary embodiments, is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel and nonobvious teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures, and/or members, or connectors, or other elements of the system, may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present disclosure. Other substitutions, modifications, changes, and omissions may be made in the design, operating conditions, and arrangement of the desired and other exemplary embodiments without departing from the spirit of the present disclosure.

Reference will now be made in detail to the present preferred embodiments of the disclosure, examples of which are illustrated in the accompanying drawings. Whenever possible, the same reference numbers will be used throughout the drawings to refer to the same or like parts.

Optical fibers are utilized to transmit data. More particularly, a transmitter converts information into pulses of electromagnetic radiation and transmits the pulses into the optical fiber. The electromagnetic radiation transmits along the optical fiber to a receiver. The receiver re-converts the pulses of electromagnetic radiation back into information.

Optical fiber often includes a solid core through which the electromagnetic radiation moves and a cladding surrounding the solid core to maintain the electromagnetic radiation within the solid core. The cladding and the solid core exhibit different indices of refraction, and the difference causes the electromagnetic radiation to stay generally within the solid core during transmission due to total internal reflection. The solid core of the optical fiber is often formed of silica-based glass.

Transmission performance of optical fibers with a solid core can suffer from confinement loss and losses due to scattering, absorption, and bending. Imperfection in the material of the solid core can cause scattering and absorption of the electromagnetic radiation pulses that the optical fiber is transmitting. Further losses of the intensity of the electromagnetic radiation from the core into the cladding occur due to external perturbations, such as bending and stresses when optical fibers are packed and deployed in cables. Confinement losses result from leaky modes in the optical fiber. Leaky modes have evanescent fields of optical signal intensity that extend beyond the core into the cladding. Losses due to scattering, absorption, and lack of confinement reduce the power of the electromagnetic radiation pulses. Reduced power limits the ability of the receiver to convert the pulses back into information, which limits the reach of the optical fiber.

In an effort to improve the performance of optical fibers, hollow core optical fibers are under development. Hollow core optical fibers mitigate attenuation of optical signals and provide further advantages such as low non-linearity, low dispersion, and low latency. Hollow core optical fibers, as the name suggests, do not include a core of solid material. Rather, the core is a gas, such as air. Due to the absence of a solid core, it is thought that the electromagnetic radiation could transmit without as much scattering and absorption loss.

The present disclosure provides a process to produce hollow core optical fibers so that the fibers have specific and uniform dimensions. Such allows the hollow core optical fibers to transmit the electromagnetic radiation with reduced attenuation.

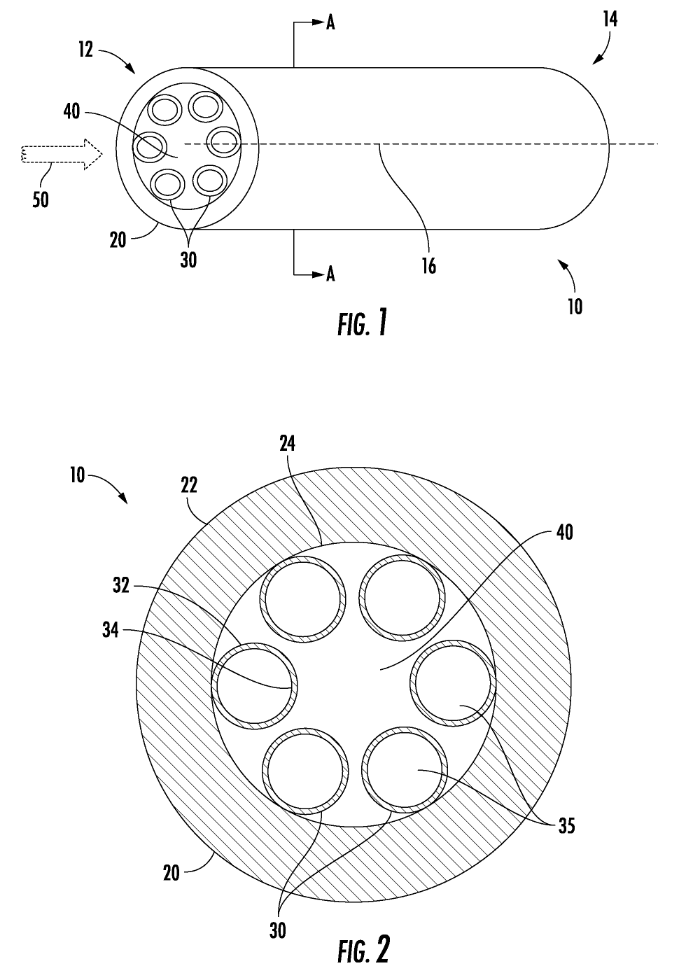

Referring now to FIG. 1, an exemplary hollow core optical fiber 10 is shown. Fiber 10 comprises a first end 12, a second end 14, and a central longitudinal axis 16. As shown in FIG. 1, fiber 10 further comprises an outer cladding 20, one or more structural tubes 30, and a hollow core 40. Outer cladding 20 and hollow core 40 extend from first end 12 to second end 14 of fiber 10. In use, electromagnetic radiation 50 enters into first end 12, transmits within hollow core 40, and exits second end 14.

FIG. 2 is a cross-sectional view of hollow core optical fiber 10 taken through line A of FIG. 1. As shown in FIG. 2, outer cladding 20 comprises an outer surface 22 and an inner surface 24. Structural tubes 30 are disposed radially around inner surface 24 of outer cladding 20 to form hollow core 40. In embodiments, structural tubes 30 are disposed azimuthally around central longitudinal axis 16. Structural tubes 30 may be in direct contact with inner surface 24 of outer cladding 20.

Outer cladding 20 is a hollow, cylindrical member formed of glass. Thus, outer cladding 20 has a hollow interior (as formed by inner surface 24) and forms a ring-like, donut shape in cross-section. In some embodiments, outer cladding 20 is formed of doped or undoped silica glass. In embodiments, outer cladding 20 consists essentially of or consists of silica-based glass. Outer cladding 20 may have a longitudinal length from about 10 centimeters (cm) to about 2 meters (m), or about 25 cm to about 1.5 m, or about 50 cm to about 1 m, or any range or combination of ranges encompassing these endpoints.

Structural tubes 30 are glass tubes disposed within the hollow interior of outer cladding 20. Similar to outer cladding 20, structural tubes 30 are hollow, cylindrical members formed of glass. Thus, structural tubes 30 each form a ring-like, donut shape in cross-section. In some embodiments, structural tubes 30 are formed of doped or undoped silica glass. In embodiments, structural tubes 30 consist essentially of or consist of silica-based glass. Structural tubes 30 may each have a longitudinal length that extends the length (or substantially the length) of outer cladding 20. Thus, structural tubes 30 and outer cladding 20 may have the same longitudinal length, which may extend from first end 12 to second end 14 of fiber 10.

As shown in FIG. 2, structural tubes 30 each comprise an outer surface 32 and an inner surface 34, such that inner surface 34 forms a hollow interior. The hollow interior of structural tubes 30 forms a capillary 35 within each structural tube 30 through which gas can flow, such as, for example, ambient air or nitrogen gas. As used herein, capillaries 35 are lumens formed by the walls of inner surface 34. A wall thickness of structural tubes 30 is carefully selected to optimize anti-resonant conditions in hollow core 40.

Hollow core 40 may be formed and defined by the outer profile of structural tubes 30. Thus, outer surface 32 of structural tubes 30 forms an outer diameter of hollow core 40. Gas such as ambient air or nitrogen gas may flow through hollow core 40. When in use, light is guided through the gas in hollow core 40 along fiber 10. Structural tubes 30 help to maintain the light within hollow core 40. Such provides transmission of optical signals along fiber 10 with reduced transmission loss.

In embodiments, hollow core optical fiber 10 is an anti-resonant hollow core optical fiber. As is known in the art, anti-resonant fibers are one type of hollow core fibers. There are three types of hollow core fibers. The first type is Bragg hollow core fibers in which the cladding is a Bragg structure of concentric periodic dielectric multilayers that confine light in a hollow (air) region. The second type is photonic bandgap hollow core fibers that use a two-dimensional photonic crystal structure with periodically arranged air holes that confine light in the hollow core region. The third type is anti-resonant hollow core fibers in which the fiber comprises one or more layers of thin glass structural tubes to prevent light from leaking out of the air core.

It is also noted that structural tub es 30 may be positioned in various configurations around inner surface 24 of outer cladding 20. FIGS. 1 and 2 show a first embodiment in which fiber 10 comprises six structural tubes 30 evenly spaced around the inner diameter of outer cladding 20. However, fiber 10 may comprise more or less structural tubes 30. For example, fiber 10 may comprise two, three, four, five, seven, eight, nine, ten, eleven, twelve, or more structural tubes 30. Furthermore, structural tubes 30 may be evenly spaced apart from each other, or structural tubes 30 may be spaced apart inconsistently from each other. In yet some embodiments, one or more structural tubes 30 may be in contact with an adjacent structural tube 30 at a contact point. However, in general, adjacent structural tubes 30 are typically separated by a gap so as to avoid the formation of a waveguide at the contact point. More specifically, such a contact point between two structural tubes can form an increased wall thickness at the contact point (due to the additive wall thickness of the two structural tubes). The increased wall thickness forms a waveguiding region, which increases the attenuation of the optical fiber.

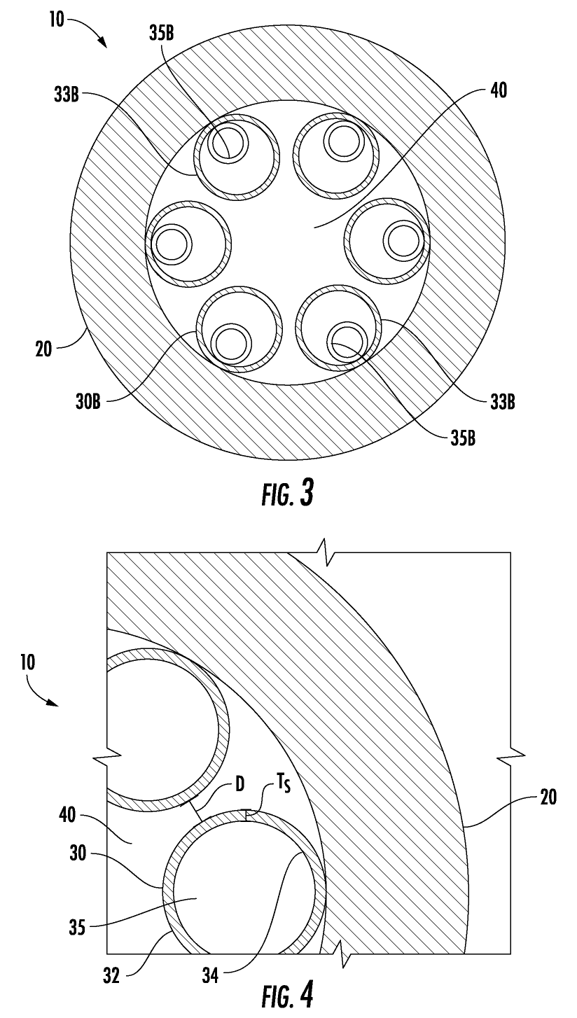

FIG. 3 shows an embodiment in which fiber 10 comprises nested structural tubes 30B. More specifically, structural tubes 30B comprise an outer tube 33B (a first structural tube) and an inner tube 35B (a second structural tube) such that inner tube 35B is nested within outer tube 33B. It is also noted that fiber 10 comprises an outer cladding 20 and a hollow core 40 in the embodiment of FIG. 3, similar to the embodiment of FIGS. 1 and 2. Furthermore, the present disclosure is not limited to the exemplary arrangements disclosed herein. Other embodiments and arrangements of structural tubes are also contemplated. For example, in other embodiments, structural tubes 30 may comprise a plurality of structural tubes nested within an outer structural tube.

Each structural tube 30 may be formed to have various sizes, including various inner and outer diameters and various wall thickness values. As shown in FIG. 4, structural tubes 30 have a wall thickness dimension T_{S}, which is defined by the inner and outer diameters of the structural tube and more specifically by outer surface 32 and inner surface 34. The size of structural tubes 30 (including the inner diameter, outer diameter, and wall thickness) affects the wavelengths at which the fiber is anti-resonant. For example, it has been found that a wall thickness T_{S} of about 300 nm to about 450 nm in a hollow core optical fiber provides zero transmission through the walls of the structural tubes (so that the fiber is anti-resonant) at wavelengths from about 1200 nm to about 1600 nm. Altering the thickness of the hollow core optical fibers to be greater or less than the 300 nm to 450 nm range may then also alter the wavelength window to be greater or less than the about 1200 nm to about 1600 nm window.

As also shown in FIG. 4, adjacent structural tubes 30 may be separated by a minimum distance D of about 30 microns or less, or about 25 microns or less, or about 20 microns or less, or about 18 microns or less, or about 15 microns or less, or about 12 microns or less, or about 10 microns or less, or about 9 microns or less, or about 8 microns or less, or about 7 microns or less, or about 6 microns or less, or about 5 microns or less, or about 4 microns or less, or about 3 microns or less, or about 2 microns or less, or about 1 micron or less, or about 0.8 microns or less, or about 0.5 microns or less, or about 0.2 microns or less, or about 0.1 microns or less, or about 0.0 microns, or any range or combination of ranges encompassed by these endpoints. For example, distance D may be in a range from about 0.0 microns to about 30 microns, or about 0.1 microns to about 25 microns, or about 0.2 microns to about 20 microns, or about 0.5 microns to about 18 microns, or about 0.8 microns to about 15 microns, or about 1 micron to about 12 microns, or about 2 microns to about 10 microns, or about 3 microns to about 9 microns, or about 4 microns to about 8 microns, or about 5 microns to about 7 microns, or about 6 microns to about 7 microns. As shown in FIG. 4, distance D is defined by the minimum distance between outer surface 32 of adjacent structural tubes 30.

Embodiments of the present disclosure are directed towards process and methods to control the dimensions of the structural tubes and the hollow core formed thereby in order to optimize the optical signal propagating within hollow core 40.

FIG. 5 provides an exemplary process 100 to produce hollow core optical fibers according to the embodiments disclosed herein. Process 100 may be utilized to produce hollow core optical fiber 10, as shown in FIGS. 1-4, or other hollow core fibers with different configurations. Thus, process 100 is not limited to the exemplary fiber structures of FIGS. 1-4.

Step 110 of process 100 comprises forming a precursor to a hollow core fiber preform. In some embodiments, step 110 of process 100 specifically comprises inserting one or more glass tubes into a core cane tube to form the preform precursor. The glass tubes may be welded to the core cane tube. In step 120, of process 100, the preform precursor is then redrawn. It is noted that step 120 is an optional step. At step 130 of process 100, the glass tubes and core cane tube are inserted into an outer cladding tube to form a hollow core optical fiber preform. At step 140, the hollow core optical fiber preform is drawn into a hollow core optical fiber.

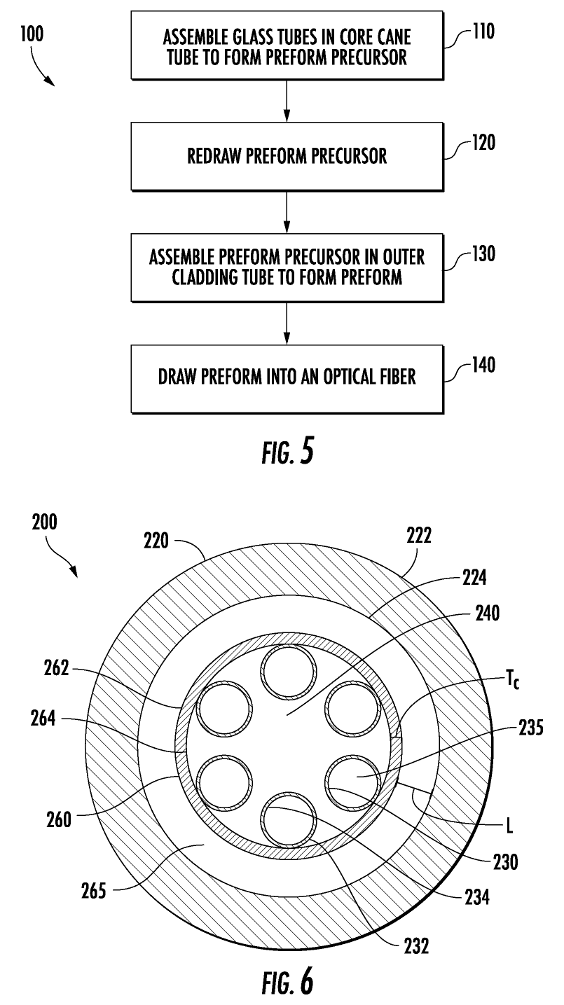

FIG. 6 shows an exemplary embodiment of a hollow core optical fiber preform 200 comprised of glass tubes 230 inserted into a core cane tube 260 and wherein the core cane tube 260 is inserted into glass cladding tube 220. Glass tubes 230 contact core cane tube 260 such that, in embodiments, glass tubes 230 are in direct contact with core cane tube 260. As discussed above, glass tubes 230 may initially be welded to core cane tube 260. A hollow core 240 is formed by glass tubes 230 in preform 200. And the walls of glass tubes 230 form inner capillaries 235. Specifically, glass tubes 230 comprise an outer surface 232 and an inner surface 234 such that inner surface 234 forms an outer diameter of inner capillaries 235. Glass tubes 230 of preform 200 become structural tubes 30 in the drawn optical fiber, capillaries 235 become capillaries 35 in the drawn optical fiber, glass cladding tube 220 becomes outer cladding 20 in the drawn optical fiber, and hollow core 240 becomes hollow core 40 in the drawn optical fiber. Furthermore, as discussed further below, core cane tube 260 becomes part of outer cladding 20 in the drawn optical fiber.

It is noted that FIG. 6 shows preform 200 after the assembling of the glass tubes to form the preform precursor (step 110), redraw (step 120) in embodiments that comprise the redraw step, and assembling of the preform precursor in the outer cladding tube to form the preform (step 130) of process 100 but before drawing of the preform into an optical fiber (step 140) of process 100. Furthermore, it is noted that FIG. 6 shows an exemplary hollow core optical fiber preform 200 and that embodiments of the present disclosure, including the steps of process 100, may be used with hollow core optical fiber preforms having other configurations than those shown in FIG. 6. Reference to the specific embodiment of FIG. 6 with regard to the steps of process 100 is used for illustrative purposes only.

Glass tubes 230 may be comprised of the same materials disclosed above with reference to structural tubes 30. And glass cladding tube 220 may be comprised of the same materials disclosed above with reference to outer cladding 20. Core cane tube 260 may be comprised of doped or undoped silica glass, similar to glass tubes 230 and glass cladding tube 220. In embodiments, core can tube 260 consists essentially of or consists of silica-based glass. Furthermore, core cane tube 260 may have the same longitudinal length (or substantially the same longitudinal length) as glass cladding tube 220.

Although FIG. 6 shows 1 core cane tube 260, it is also contemplated in embodiments that preform 200 may comprise 2 or more, or 3 or more, or 4 or more, or 5 or more, or 6 or more, or 7 or more, or 8 or more, or 9 or more, or 10 or more core cane tubes 260. The one or more core cane tubes 260 may each be radially concentric with each other and with core cladding tube 220 in cross-section. In other embodiments one or more core cane tubes 260 may be radially non-concentric with one or more other core cane tubes 260 and/or with core cladding tube 220 in cross-section. The plurality of core cane tubes 260 may each be separated from each other by a gap.

As shown in FIG. 6, outer cladding tube 220 comprises an outer surface 222 and an inner surface 224, and core cane tube 260 comprises an outer surface 262 and an inner surface 264. Furthermore, core cane tube 260 is spaced apart from outer cladding tube 220 by a gap 265, which forms a hollow interior within preform 200. A length L of gap is defined by the minimum distance between outer surface 262 and inner surface 224. Length L may be about 1 millimeters (mm) to about 10 mm, or about 2 mm to about 9 mm, or about 3 mm to about 8 mm, or about 4 mm to about 7 mm, or about 5 mm to about 6 mm, or any range or combination of ranges encompassing these endpoints.

Gas such as ambient air or nitrogen gas may flow through gap 265, similar to hollow core 240. Although core cane tube 260 is spaced apart from outer cladding tube 220, core cane tube 260 may be in direct contact with each of the glass tubes 230.

As discussed further below, gap 265 helps to control the expansion of glass tubes 230 during the drawing process of preform 200 so that structural tubes 30 in the drawn optical fiber have specific dimensions and are uniform. Furthermore, core cane tube 260 has a thickness T_{C}, which is the difference between the diameter of outer surface 262 and the diameter of inner surface 264. As also discussed further below, the thickness T_{C} is controlled to provide a structurally strong core cane tube 260 in order to produce structural tubes with the specific and uniform dimensions.

With reference again to process 100, at step 120, the preform precursor may be heated to a temperature above the softening point of glass and stretched into a smaller diameter during the redraw step. As discussed above, step 120 is an optional step. At the conclusion of step 130, preform 200 may be produced and ready for drawing into an optical fiber.

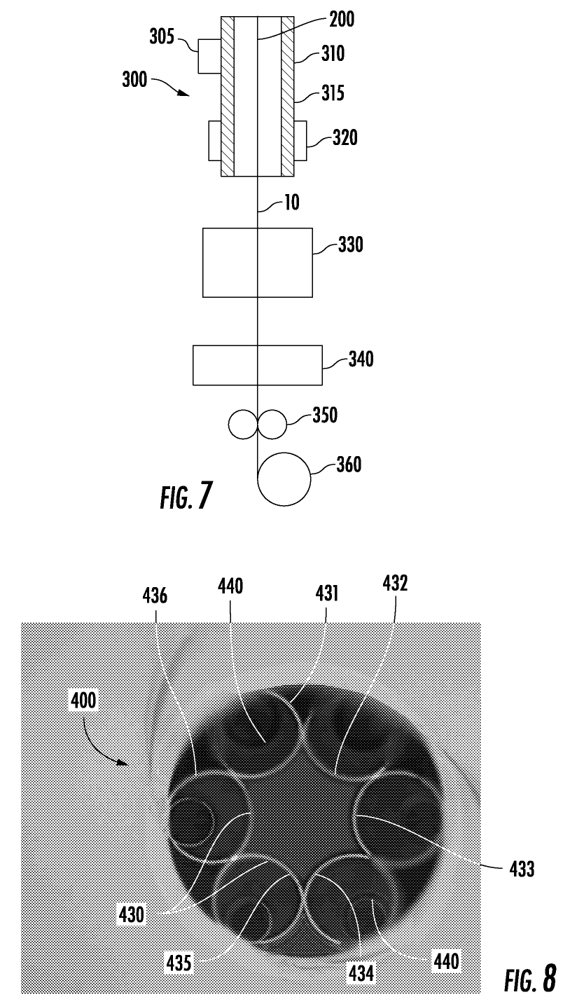

At step 140 of process 100, hollow core optical fiber preform 200 is drawn into an optical fiber (such as hollow core optical fiber 10). FIG. 7 depicts an exemplary fiber drawing system 300 that comprises a draw furnace 310 with a heating element 320 and a muffle 315. Hollow core optical fiber preform 200 is disposed vertically in draw furnace 300, and heating element 320 of draw furnace 310 applies heat to at least a bottom portion of preform 200. Optical fiber 10 (in the form of a bare, uncoated optical fiber) is then drawn from the heated preform 200.

In order to draw fiber 10, a root portion of preform 200 is pulled by a tractor 350 and wound onto a spoon or reel 360. System 300 may comprise additional components such as a monitor 330 to monitor and measure the dimensions of optical fiber 10 and/or the draw speed of optical fiber 10. In embodiments, monitor 330 monitors and measures the diameter dimensions of outer cladding 20, structural tubes 30 (including nested glass tubes such as outer tubes 33B and inner tubes 35B), and/or hollow core 40, including the inner and outer diameters of each of these components. System 300 may also comprise an adjustment mechanism 305 to measure and control/adjust one or more preform properties (such as the pressure within hollow core optical fiber preform 200). It is also noted that in embodiments, monitor 330 and/or adjustment mechanism 305 may be separate components from fiber drawing system 300. In the embodiment shown in FIG. 7, fiber drawing system 300 encompasses both monitor 330 and adjustment mechanism 305.

Additionally, as shown in FIG. 7, system 300 may further comprise a coating apparatus 340. Optical fiber 10 is a bare, uncoated fiber until reaching coating apparatus 340, which may apply a polymeric-based coating to an outside surface of the bare optical fiber. The coated fiber may then pass through a coating curing apparatus (not shown) before being wound on reel 360.

During the drawing of preform 200 into hollow core optical fiber 10, the top of the preform is sealed and the bottom is effectively sealed as the bottom diameter becomes so small when drawn into fiber 10. Therefore, the interior of preform 200 is effectively a closed container subject to the ideal gas law: PV=nRT, where P is the pressure of the gas within the closed container, V is the volume of the gas within the closed container, n is the number of moles of the gas within the closed container, R is the ideal gas constant, and T is the temperature of the gas within the closed container. The ideal gas law shows the relationship between temperature, pressure, volume, and number of moles of a gas.

In embodiments, the top of the preform is sealed to form the closed container within the preform. In particular, the interior of each glass tube 230, the interior of hollow core 240, and the interior of gap 265 each forms a separate closed container through which the pressure can be controlled independently of each other. Therefore, for example, the pressure within a first glass tube 230 can be controlled separately from the pressure within a second glass tube 230. As another example, the pressure within a glass tube 230 can be controlled separately from the pressure within gap 265. In other embodiments, a pressure control tube is connected to one or more of the interior of each glass tube 230, the interior of hollow core 240, and the interior of gap 265 to from the separate closed containers that can be controlled independently of each other.

As shown by the ideal gas law, increasing the temperature inside the closed container causes a corresponding increase in pressure within the closed container. As discussed above, when preform 200 is drawn into optical fiber 10, heating element 320 heats preform 200. More specifically, heating element 320 heats a bottom portion of preform 220 to its glass melt temperature (e.g., about 2000℃) in order to draw the preform into optical fiber 10. This heating of preform 200 causes the pressure within the preform to increase (as demonstrated by the ideal gas law). In particular, with reference to FIG. 6, the pressure of the gas within glass tubes 230 increases, causing glass tubes 230 to expand so that the size of inner capillaries increases 235 and a wall thickness of glass tubes 230 decreases (similar to the expansion of a balloon when it is blown up). Due to the expansion of glass tubes 230, capillaries 35 in the drawn fiber 10 are larger than inner capillaries 235 in preform 200. Therefore, inner surface 34 of capillaries have a larger diameter than inner surface 234 of glass tubes 230. And structural tubes 30 in the drawn fiber 10 have a smaller wall thickness than glass tubes 230 in preform 200.

An object of this disclosure is to control the expansion of the glass tubes 230 as they expand into structural tubes 30 so that structural tubes 30 are formed with specific and precise dimensions. Another object of this disclosure is to control the expansion of glass tubes 230 so that structural tubes 30 are uniformly expanded. In some embodiments, the expansion of glass tubes 30 into structural tubes 230 is controlled so that structural tubes 230 do not contact each other. Core cane tube 260 in preform 200 allows the expansion of glass tubes 230 to be controlled so that structural tubes 230 are formed with such specific, precise, and uniform dimensions.

Without the presence of core cane tube 260, a problem that may occur during the drawing of the preform is that the glass tubes may over-expand with the expansion of the outer cladding tube. The glass tubes are relatively thinner than the outer cladding tube so that they expand more easily from a little amount of pressure as compared with the outer cladding tube. Therefore, the glass tubes are more expandable relative to the outer cladding tube during the draw process. But, in conventional hollow core optical fiber preforms, the glass tubes are directly connected to the outer cladding tube. This direct connection between the glass tubes and the outer cladding tube can be a problem when coupled with the expandability of the glass tubes. More specifically, when drawing a conventional preform into an optical fiber, the glass tubes expand to a larger dimension while the outer cladding tube has barely expanded. The outer cladding tube may then be further expanded until it reaches its desired dimensions. Because the glass tubes are directly connected to the outer cladding tube, the further expansion of the outer cladding tube may cause the glass tubes to be over-expanded, which results in broken glass tubes or glass tubes that contact each other in the drawn fiber.

Furthermore, without the presence of core cane tube 260, one or more glass tubes in a conventional preform may expand unevenly from the other glass tubes during the drawing of the preform. Such may cause the glass tubes to form structural tubes that are uneven in size (with regard to the other structural tubes). The over-expansion of structural tubes may cause the tubes to contact each other or, in some cases, to even break. FIG. 8 shows an image of a comparative optical fiber 400 that comprises six outer structural tubes 430 (i.e., structural tubes 431-436) along with inner structural tubes 440. In this comparative example, optical fiber 400 was drawn from a conventional preform that did not include a core cane tube with a gap between the core cane tube and an outer cladding tube. As such, structural tubes 431-436 in optical fiber 400 were over-expanded during the draw process such that these structural tubes contact their adjacent structural tube(s), resulting in increased attenuation of optical fiber 400. Furthermore, the structural tubes do not all have the same circular and symmetric cross-sectional dimensions.

With reference again to FIG. 6, in the exemplary embodiments disclosed herein, preform 200 comprises core cane tube 260 such that gap 265 is disposed between core cane tube 260 and outer cladding tube 220. Such provides room for glass tubes 230 to fully expand with a controlled pressure during the drawing of preform 200 into optical fiber 10. More specifically, when glass tubes 230 expand (due to the increased pressure within the tubes from the heating of preform 200), core cane tube 260 also expands. The expansion of core cane tube 260 causes the length L between outer surface 262 of core cane tube 260 and inner surface 264 of outer cladding 220 to decrease.

The presence of gap 265 between glass tubes 230 and outer cladding tube 220 advantageously provides room for glass tubes 230 to expand without being restricted by outer cladding tube 220. Thus, the presence of gap 265 advantageously allows glass tubes 230 to each expand to their desired dimensions before the glass tubes 230 contact outer cladding tube 220. As discussed above, glass tubes 230 are more expandable relative to outer cladding tube 220 during the draw process, so that glass tubes 230 want to expand more but are restricted by outer cladding tube 220. But, with gap 265 between core cane tube 260 and outer cladding tube 220, glass tubes 230 are separated from outer cladding tube 220 during this expansion process. Therefore glass tubes 230 can expand uniformly and to their full desired dimension without being restricted by the limited expansion of outer cladding tube 220. Such allows glass tubes 230 to expand into uniform structural tubes 30 in the drawn fiber that do not contact each other. Furthermore, such allows glass tubes 230 to expand into structural tubes 30 that are advantageously separated by a very small distance D in the drawn optical fiber (wherein the distance D is discussed above with reference to FIG. 4).

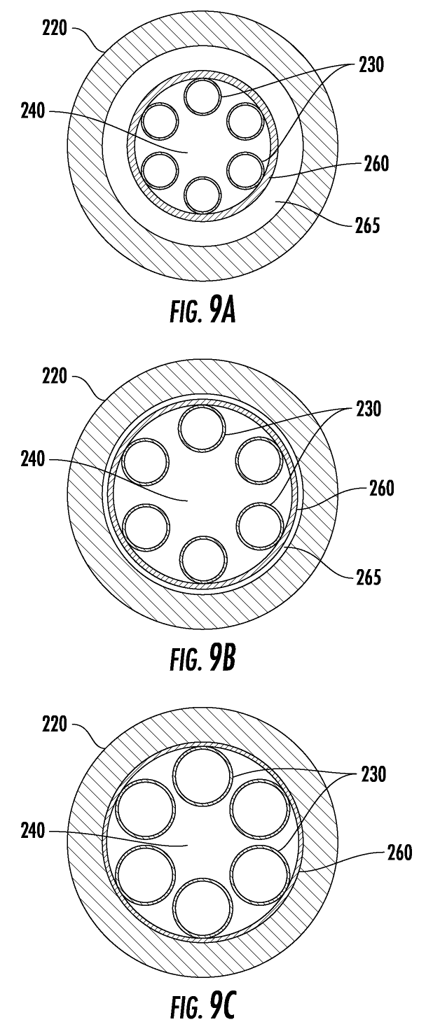

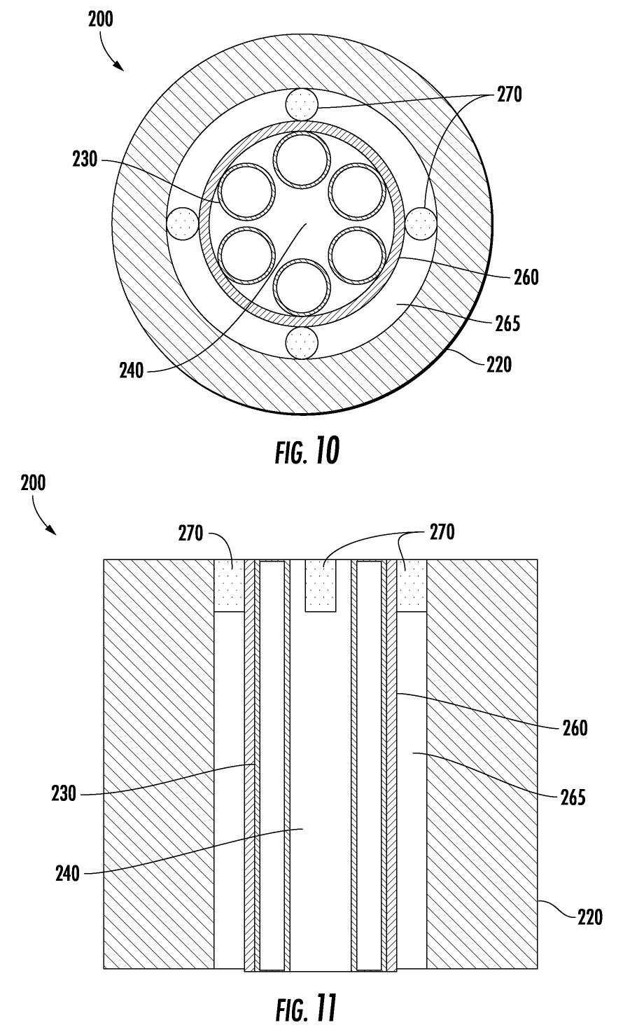

As core cane tube 260 radially expands outward, during the draw of preform 200, core cane tube 260 eventually merges with outer cladding tube 220 so that core cane tube 260 forms part of outer cladding 20 in the drawn optical fiber. FIGS. 9A-9C show cross-sections of preform 200 at various positions within furnace 300 during the drawing of preform 200 into optical fiber 10. FIG. 9A shows a portion of preform 200 toward a top end of furnace 300, relatively furthest from heating element 320. As shown in FIG. 9A, this portion of preform 200 comprises gap 265 between core cane tube 260 and outer cladding tube 220. FIG. 9B shows a portion of preform 200 as the preform is consumed into the optical fiber and moved relatively closer to heating element 320 within furnace 300. As shown in FIG. 9B, gap 265 becomes smaller as the temperature of preform 200 increases and the pressure within preform 200 increases. FIG. 9C shows a portion of preform toward a bottom end of furnace 300, relatively closest to heating element 320, as the preform continues to be consumed and drawn into the optical fiber. As shown in FIG. 9C, gap 265 no longer exists between core cane tube 260 and outer cladding tube 220. Instead, core cane tube 260 merges with outer cladding tube 220 to form outer cladding 20 in the drawn optical fiber 10. Thus, gap 265 is not present in the drawn optical fiber. It is also noted that due to the presence of core cane tube 260 and gap 265 between core cane tube 260 and outer cladding tube 220, glass tubes 230 expand evenly and uniformly in FIGS. 9A-9C.

In the embodiments that comprise more than one core cane tube 260, the multiple core cane tubes merge with each other and with outer cladding tube 220 to all form outer cladding 20 in the drawn optical fiber 10.

With reference again to FIG. 6, before preform 200 is drawn into an optical fiber, outer surface 232 of glass tubes 230 has an outer diameter from about 5 mm to about 25 mm, or about 8 mm to about 22 mm, or about 10 mm to about 20 mm, or about 12 mm to about 18 mm, or about 14 mm to about 16 mm, or any range or combination of ranges encompassing these endpoints. A wall thickness of glass tubes 230 (the difference between outer surface 232 and inner surface 234), before preform 200 is drawn into an optical fiber, is from about 0.50 mm to about 2.00 mm, or about 0.75 mm to about 1.75 mm, or about 1.00 mm to about 1.50 mm, or about 1.25 mm to about 1.50 mm, or any range or combination of ranges encompassing these endpoints. As discussed above, glass tubes 230 can be single, nested, or double nested in structure to form single, nested, or double nested structural tubes 230.

Before preform 200 is drawn into an optical fiber, outer surface 222 of outer cladding tube 220 has an outer diameter from about 60 mm to about 200 mm, or about 70 mm to about 190 mm, or about 80 mm to about 180, or about 90 mm to about 170 mm, or about 100 mm to about 160 mm, or about 110 mm to about 150 mm, or about 120 mm to about 140 mm, or about 130 mm to about 140 mm, or any or any range or combination of ranges encompassing these endpoints. A wall thickness of outer cladding tube 220 (the difference between outer surface 222 and inner surface 224), before preform 200 is drawn into an optical fiber, is from about 10 mm to about 30 mm, or about 12 mm to about 28 mm, or about 14 mm to about 26 mm, or about 16 mm to about 24 mm, or about 18 mm to about 22 mm, or about 20 mm to about 22 mm, or any or any range or combination of ranges encompassing these endpoints.

Before preform 200 is drawn into an optical fiber, outer surface 262 of core cane tube 260 has an outer diameter from about 30 mm to about 120 mm, or about 40 mm to about 110 mm, or about 50 mm to about 100 mm, or about 60 mm to about 90 mm, or about 70 mm to about 80 mm, or any range or combination of ranges encompassing these endpoints. The wall thickness T_{C} of core cane tube 260 (the difference between outer surface 262 and inner surface 264), before preform 200 is drawn into an optical fiber, is from about 1 mm to about 7 mm, or about 2 mm to about 6 mm, or about 3 mm to about 5 mm, or about 4 mm to about 5 mm, or any range or combination of ranges encompassing these endpoints.

In the embodiments disclosed herein, inner surface 224 of outer cladding tube 220 is larger than outer surface 262 of core cane tube 260, thus providing gap 266. As discussed above, the length L of gap 265, before preform 200 is drawn into an optical fiber, is from about 1 mm to about 10 mm, or about 2 mm to about 9 mm, or about 3 mm to about 8 mm, or about 4 mm to about 7 mm, or about 5 mm to about 6 mm, or any range or combination of ranges encompassing these endpoints.

FIG. 10 shows another embodiment of hollow core optical fiber preform 200 in which the preform comprises spacers 270 within gap 265. Spacers 270 may be tubular or rod-like members that help to stabilize core cane tube 260 with regard to outer cladding tube 220. A longitudinal length of spacers 270 may be less than the longitudinal length of each of core cane tube 260, glass tubes 230, and outer cladding tube 220. In embodiments, spacers 270 each have a longitudinal length of about 1 cm or greater, or about 2 cm or greater, or about 3 cm or greater, or about 4 cm or greater, or about 5 cm or greater, or about 6 cm or greater, or about 7 cm or greater, or about 8 cm or greater, or about 9 cm or greater, or about 10 cm or greater, or from about 1 cm to about 10 cm, or about 2 cm to about 9 cm, or about 3 cm to about 8 cm, or about 4 cm to about 7 cm, or about 5 cm to about 6 cm, or any range or combination of ranges encompassing these endpoints. One or more spacers 270 may be a hollow, cylindrical member formed of glass. Thus, one or more spacers 270 may comprise a hollow interior and may form a ring-like, donut shape in cross-section. In some embodiments, one or more spacers 270 may be a solid, rod-like member, such as that shown in the embodiment of FIG. 10. Spacers 270 may be formed of doped or undoped silica glass. In embodiments, spacers 270 consists essentially of or consists of silica-based glass.

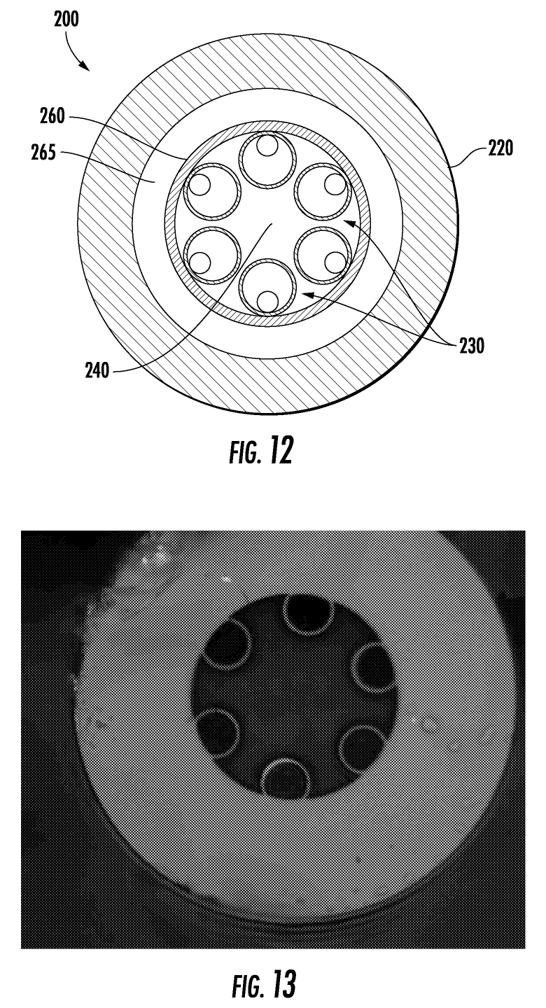

FIG. 11 shows a cross-sectional view of preform 200 along the longitudinal axis of the preform. As shown in FIG. 11, spacers 270 only extend for a shortened length along the longitudinal length of core cane tube 260. Spacers 270 may help to stabilize core cane tube 260 so that it remains properly positioned with regard to outer cladding tube 220, thus providing gap 265 with a specific length L. In embodiments, spacers 270 may be welded or otherwise secured to each of core cane tube 260 and outer cladding tube 220. During the drawing of preform 200 into an optical fiber, spacers 270 may be expanded and fuse into outer cladding tube 220 to become part of outer cladding 20 in the drawn optical fiber.

FIG. 12 shows another embodiment of preform 200 in which glass tubes 230 comprise nested glass tubes. In this embodiment, glass tubes 230 comprise an outer tube and an inner, nested tube. However, it is also contemplated that one or more glass tubes 230 may comprise more than one inner, nested tube within an outer tube.

### Exemplary Example

An optical fiber was produced using the steps of process 100. First, a preform precursor was assembled by inserting 6 glass tubes into a core cane tube. Each glass tube comprised an inner diameter of about 2.08 mm, an outer diameter of about 2.80 mm, and an aspect ratio (ratio of length to width) of about 0.745. The core cane tube comprised an inner diameter of about 13 mm and an outer diameter of about 15 mm. The 6 glass tubes were each welded to the core cane tube using a hydrogen/oxygen torch. Then, the assembled glass tubes and core cane tube was inserted into an outer cladding tube. The outer cladding tube comprised an inner diameter of about 16.1 mm and an outer diameter of about 33.6 mm. No spacers were in this exemplary example.

The assembled preform was then sealed in order to control the gas pressure within the hollow core.

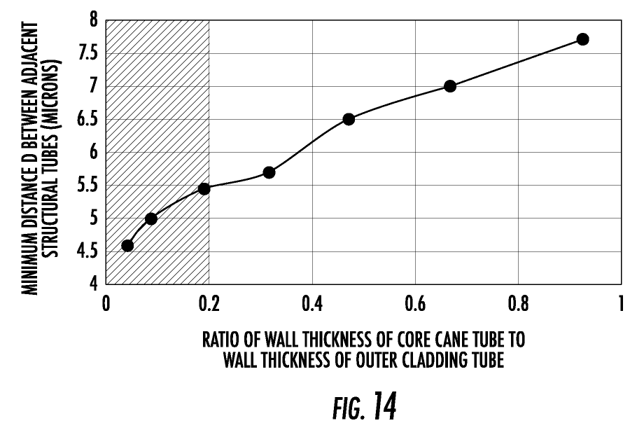

During the drawing of the preform into an optical fiber, the preform was down fed within a draw furnace at a rate between about 1 mm/min to about 10 mm/min with a draw speed from about 20 m/min to about 30 m/s. The furnace had a maximum internal temperature from about 1700℃ to about 2050℃, and the hollow core had an internal pressure from about 0 psi to about 2 psi while the glass tubes had an internal pressure from about 0 psi to about 5 psi. FIG. 13 shows an image of the drawn optical fiber. Due to the presence of the core cane tube in the preform, the fiber was drawn to have uniform structural tubes.

FIG. 14 shows the relationship between a ratio of the wall thickness (T_{c}) of core cane tube 260 to the wall thickness of outer cladding tube 220 in preform 200 with the distance D between structural tubes 30 in the drawn optical fiber 10. In embodiments, the ratio of the wall thickness of core cane tube 260 to the wall thickness of outer cladding tube 220 is small in order to provide a smaller distance D. However, if the wall thickness of core cane tube 260 is too small, the core cane tube 260 may not be structurally strong enough to support glass tubes 230. In such cases, when the core cane tube 260 is not structurally strong, glass tubes 230 will deform when expanding, resulting in non-uniform structural tubes 30 in the drawn fiber. Therefore, in embodiments, the ratio of the wall thickness of core cane tube 260 to the wall thickness of outer cladding tube 220 is less than or equal to about 0.100 or greater than or equal to about 0.25. In some embodiments, the ratio of the wall thickness of core cane tube 260 to the wall thickness of outer cladding tube 220 is in a range from about 0.004 to about 0.100, or about 0.005 to about 0.090, or about 0.008 to about 0.060, or about 0.010 to about 0.050, or about 0.020 to about 0.040, or any range or combination of ranges encompassing these endpoints. In other embodiments, the ratio of the wall thickness of core cane tube 260 to the wall thickness of outer cladding tube 220 is in a range from about 0.25 to about 1.20, or about 0.30 to about 1.10, or about 0.40 to about 1.00, or about 0.50 to about 0.90, or about 0.60 to about 0.80, or about 0.70 to about 0.80, or any range or combination of ranges encompassing these endpoints. In some particular embodiments, the ratio of the wall thickness of core cane tube 260 to the wall thickness of outer cladding tube 220 is 0.056, 0.067, 0.072, 0.40, 0.45, or 0.53.

According to a first aspect, a hollow core optical fiber preform comprising a core cane tube positioned radially within a hollow interior of an outer cladding tube such that an outer surface of the core cane tube is separated by an inner surface of the outer cladding tube by a gap, and one or more glass tubes positioned radially within a hollow interior of the core cane tube, the one or more glass tubes each contacting the core cane tube, and the one or more glass tubes each comprising an inner capillary.

According to a second aspect, the hollow core optical fiber preform of the first aspect, wherein the one or more glass tubes comprise a plurality of glass tubes and adjacent glass tubes of the plurality of glass tube do not contact each other.

According to a third aspect, the hollow core optical fiber of the first or aspect, wherein the gap has a length from about 1 mm to about 10 mm.

According to a fourth aspect, the hollow core optical fiber of the third aspect, wherein the length of the gap is from about 3 mm to about 8 mm.

According to a fifth aspect, the hollow core optical fiber of any one of the first through fourth aspects, wherein a thickness of the outer cladding tube is greater than a thickness of the core cane tube.

According to a sixth aspect, the hollow core optical fiber of any one of the first through fifth aspects, wherein an outer surface of the one or more glass tubes forms a hollow core of the hollow core optical fiber preform.

According to a seventh aspect, the hollow core optical fiber of any one of the first through sixth aspects, wherein a longitudinal length of the core cane tube is substantially equal to a longitudinal length of the outer cladding tube.

According to an eighth aspect, the hollow core optical fiber of any one of the first through seventh aspects, further comprising one or more spacers positioned within the gap, the one or more spacers each contacting the core cane tube and the outer cladding tube.

According to a ninth aspect, the hollow core optical fiber of the eighth aspect, wherein the one or more spacers each have a longitudinal length less than a longitudinal length of the core cane tube.

According to a tenth aspect, the hollow core optical fiber of any one of the first through ninth aspects, wherein the core cane tube has a thickness from about 1 mm to about 7 mm.

According to an eleventh aspect, the hollow core optical fiber of the tenth aspect, wherein the thickness of the core cane tube is from about 2 mm to about 6 mm.

According to a twelfth aspect, the hollow core optical fiber of any one of the first through eleventh aspects, wherein a ratio of a thickness of the core cane tube to a thickness of the outer cladding tube is greater than 0.2.

According to a thirteenth aspect, the hollow core optical fiber of the twelfth aspect, wherein the ratio of the thickness of the core cane tube to the thickness of the outer cladding tube is in a range from 0.2 to 0.8.

According to a fourteenth aspect, the hollow core optical fiber of the thirteenth aspect, wherein the ratio of the thickness of the core cane tube to the thickness of the outer cladding tube is in a range from 0.2 to 0.4.

According to a fifteenth aspect, the hollow core optical fiber of any one of the first through fourteenth aspects, wherein the one or more glass tubes directly contact the core cane tube.

According to a sixteenth aspect, the hollow core optical fiber of any one of the first through fifteenth aspects, further comprising inner, nested tubes within the one or more glass tubes.

According to a seventeenth aspect, a method of manufacturing a hollow core optical fiber from a hollow core optical fiber preform, the method comprising positioning one or more glass tubes radially within a core cane tube and positioning the core cane tube radially within an outer cladding tube such that the core cane tube is separated from the outer cladding tube by a gap, controlling gas pressure within the one or more glass tubes so that the glass tubes radially expand in size, and controlling gas pressure within a hollow core of the hollow core optical fiber so that the core cane tube radially expands in size such that a length of the gap decreases.

According to an eighteenth aspect, the method of the seventeenth aspect, further comprising expanding the core cane tube so that the core cane tube merges with the outer cladding tube.

According to a nineteenth aspect, the method of the seventeenth or eighteenth aspect, wherein the one or more glass tubes are positioned within the core cane tube before the core cane tube is positioned with the outer cladding tube.

According to a twentieth aspect, the method of any one of the seventeenth through nineteenth aspects, further comprising welding the one or more glass tubes to the core cane tube.

According to a twenty-first aspect, the method of any one of the seventeenth through twentieth aspects, wherein the gas pressure within the one or more glass tubes is controlled separately from the gas pressure within the hollow core.

According to a twenty-second aspect, the method of any one of the seventeenth through twenty-first aspects, wherein the glass tubes in the hollow core optical fiber preform form structural tubes in the hollow core optical fiber, and wherein a minimum distance D between adjacent structural tubes is about 30 microns or less.

According to a twenty-third aspect, the method of the twenty-second aspect, wherein the distance D is about 10 microns or less.

According to a twenty-fourth aspect, the method of the twenty-second aspect, wherein the distance D is in a range from about 0.1 microns to about 25 microns.

According to a twenty-fifth aspect, the method of any one of the seventeenth through twenty-fourth aspects, further comprising controlling gas pressure within the gap.

According to a twenty-sixth aspect, the method of any one of the twenty-fifth through twenty-seventh aspects, wherein the core cane tube in the hollow core optical fiber preform has a thickness from about 1 mm to about 7 mm.

According to a twenty-seventh aspect, the method of the twenty-sixth aspect, wherein the thickness of the core cane tube in the hollow core optical fiber preform is from about 2 mm to about 6 mm.

According to a twenty-eighth aspect, the method of any one of the seventeenth through twenty-seventh aspects, wherein a ratio of a thickness of the core cane tube to a thickness of the outer cladding tube in the hollow core optical fiber preform is greater than 0.2.

According to a twenty-ninth aspect, the method of the twenty-eighth aspect, wherein the ratio of the thickness of the core cane tube to the thickness of the outer cladding tube in the hollow core optical fiber preform is in a range from 0.2 to 0.8.

According to a thirtieth aspect, the method of the twenty-ninth aspect, wherein the ratio of the thickness of the core cane tube to the thickness of the outer cladding tube in the hollow core optical fiber preform is in a range from 0.2 to 0.4.

According to a thirty-first aspect, the method of any one of the seventeenth through thirtieth aspects, wherein the one or more glass tubes directly contact the core cane tube in the hollow core optical fiber preform.

While various embodiments have been described herein, they have been presented by way of example only, and not limitation. It should be apparent that adaptations and modifications are intended to be within the meaning and range of equivalents of the disclosed embodiments, based on the teaching and guidance presented herein. It therefore will be apparent to one skilled in the art that various changes in form and detail can be made to the embodiments disclosed herein without departing from the spirit and scope of the present disclosure. The elements of the embodiments presented herein are not necessarily mutually exclusive, but may be interchanged to meet various needs as would be appreciated by one of skill in the art.

It is to be understood that the phraseology or terminology used herein is for the purpose of description and not of limitation. The breadth and scope of the present disclosure should not be limited by any of the above-described exemplary embodiments but should be defined only in accordance with the following claims and their equivalents.

What is claimed is:

1. A hollow core optical fiber preform comprising:
a core cane tube positioned radially within a hollow interior of an outer cladding tube such that an outer surface of the core cane tube is separated by an inner surface of the outer cladding tube by a gap; and
one or more glass tubes positioned radially within a hollow interior of the core cane tube, the one or more glass tubes each contacting the core cane tube, and the one or more glass tubes each comprising an inner capillary.

2. The hollow core optical fiber preform of claim 1, wherein the one or more glass tubes comprise a plurality of glass tubes and adjacent glass tubes of the plurality of glass tube do not contact each other.

3. The hollow core optical fiber preform of claim 1, wherein the gap has a length from about 1 mm to about 10 mm.

4. The hollow core optical fiber preform of claim 3, wherein the length of the gap is from about 3 mm to about 8 mm.

5. The hollow core optical fiber preform of claim 1, wherein a thickness of the outer cladding tube is greater than a thickness of the core cane tube.

6. The hollow core optical fiber of claim 1, wherein an outer surface of the one or more glass tubes forms a hollow core of the hollow core optical fiber preform.

7. The hollow core optical fiber preform of claim 1, wherein a longitudinal length of the core cane tube is substantially equal to a longitudinal length of the outer cladding tube.

8. The hollow core optical fiber preform of claim 1, further comprising one or more spacers positioned within the gap, the one or more spacers each contacting the core cane tube and the outer cladding tube.

9. The hollow core optical fiber preform of claim 8, wherein the one or more spacers each have a longitudinal length less than a longitudinal length of the core cane tube.

10. The hollow core optical fiber preform of claim 1, wherein the core cane tube has a thickness from about 1 mm to about 7 mm.

11. The hollow core optical fiber preform of claim 10, wherein the thickness of the core cane tube is from about 2 mm to about 6 mm.

12. The hollow core optical fiber preform of claim 1, wherein a ratio of a thickness of the core cane tube to a thickness of the outer cladding tube is less than or equal to about 0.100 or greater than or equal to about 0.25.

13. The hollow core optical fiber preform of claim 12, wherein the ratio of the thickness of the core cane tube to the thickness of the outer cladding tube is in a range from about 0.004 to about 0.100.

14. The hollow core optical fiber preform of claim 12, wherein the ratio of the thickness of the core cane tube to the thickness of the outer cladding tube is in a range from about 0.25 to about 1.20.

15. The hollow core optical fiber preform of claim 1, wherein the one or more glass tubes directly contact the core cane tube.

16. The hollow core optical fiber preform of claim 1, further comprising inner, nested tubes within the one or more glass tubes.

17. A method of manufacturing a hollow core optical fiber from a hollow core optical fiber preform, the method comprising:
positioning one or more glass tubes radially within a core cane tube and positioning the core cane tube radially within an outer cladding tube such that the core cane tube is separated from the outer cladding tube by a gap;
controlling gas pressure within the one or more glass tubes so that the glass tubes radially expand in size; and
controlling gas pressure within a hollow core of the hollow core optical fiber preform so that the core cane tube radially expands in size such that a length of the gap decreases.

18. The method of claim 17, further comprising expanding the core cane tube so that the core cane tube merges with the outer cladding tube.

19. The method of claim 17, wherein the one or more glass tubes are positioned within the core cane tube before the core cane tube is positioned with the outer cladding tube.

20. The method of claim 17, further comprising welding the one or more glass tubes to the core cane tube.
